(19) United States
(12) Patent Application Publication
(10) Pub. No.: US 2011/0012063 A1
(43) Pub. Date: Jan. 20, 2011

(54) METHOD AND SYSTEM FOR PRODUCING METHANE ENRICHED BIOGAS

(75) Inventors: Amir Assa, Nahariya (IL); Lior Zaid, Kfar Rosh Hanikra (IL)

Correspondence Address: THE NATH LAW GROUP, 112 South West Street, Alexandria, VA, 22314, US

(73) Assignee: CITRINE-RENEWABLE ENERGY LTD., Nahariya (IL)

(21) Appl. No.: 12/810,990

(22) PCT Filed: Dec. 25, 2008
(86) PCT No.: PCT/IL08/01677

§ 371 Date: Oct. 5, 2010

Related U.S. Application Data
(60) Provisional application No. 61/009,218, filed on Dec. 27, 2007.

(51) Int. Cl. C09K 3/00; B01J 8/02

(52) U.S. Cl. 252/372; 422/187

(57) ABSTRACT

A method and system for producing methane from raw biogas is provided, including absorption of biogas components with basic aqueous solution and treating the resultant solution in order to regenerate basic aqueous solution and harmless decomposed organic and non-organic components of biogas.

### FIELD OF THE INVENTION

This invention relates to the field of biogas purification.

### BACKGROUND OF THE INVENTION

The use of methane as a fuel for various types of energy generating engines is growing. Sources of methane gas are varied and include biogas from biological degradation of sewage waste or digester gas, foodstuff waste, animal feed lot waste, land fills and so forth. Typically, gaseous products from these sources are heavily contaminated with carbon dioxide and hydrogen sulfide. Hydrogen sulfide must be removed from the biogas because of its toxicity and odor, and carbon dioxide must be removed because it reduces the heating value of the gas and is harmful when the gas is used as fuel for engine operated machines.

Methods for removing contaminants from gases are known. Carbon dioxide and hydrogen sulfide can be absorbed from methane by passing the biogas stream countercurrent through water or aqueous solutions containing basic components. The water or aqueous solutions absorb the carbon dioxide and hydrogen sulfide. Usually, these methods employ large quantities of water in order to achieve a high purity methane gas. Although additional methods are known for de-sorbing the resulting contaminated solutions, such as for example stripping the resulting solution with air and other absorbent or adsorbent materials, the waste produced as by-products of these methods is environmentally harmful and expensive to discard.

EP 0 180 670 relates to an apparatus and method for recovering biogas, having a series of spray scrubbers for scrubbing biogas from CO₂ and regenerating the absorbent liquid after further scrubbing.

U.S. Pat. No. 5,354,545 relates to processes for removal of sulphur compounds from a gaseous effluent with an aqueous solution the pH of which is adjusted and maintained throughout the process. In this process the resulting aqueous solution is subjected to sulphide oxidizing bacteria in order to separate elemental sulphur.

WO 2007/021183 describes a process for purification of methane rich streams involving adsorption of contaminants with a catalytic conversion unit after cooling the pressurized gas stream.

As any method of technology at all times, these methods can be improved upon to become more efficient, reliable, cost-effective, versatile, and less harmful to the environment.

### SUMMARY OF THE INVENTION

The subject invention now provides such an efficient, reliable, cost-effective, versatile and environment-friendly method for the production of a high yield of purified methane from raw biogas.

In one aspect of the present invention there is provided a method of producing methane-enriched biogas from raw biogas, said method comprising the steps:
(a) introducing into at least one absorption column (i) raw biogas and (ii) a basic aqueous solution under conditions to permit solubilization of aqueous-soluble biogas components in the basic aqueous solution to obtain (i) methane-enriched biogas and (ii) at least one basic aqueous solution comprising aqueous-soluble biogas components;
(b) collecting the methane-enriched biogas;
(c) collecting the at least one basic aqueous solution comprising said aqueous-soluble biogas components;
(d) subjecting the at least one basic aqueous solution comprising said aqueous-soluble biogas components to a treatment for removal of said aqueous-soluble biogas components, to obtain a basic aqueous solution of step (a);
(e) feeding a first portion of the basic aqueous solution obtained in step (d) into at least one absorption column of step (a);
(f) subjecting a second portion of the basic aqueous solution obtained in step (d) to at least one biological purification process to obtain a purified basic aqueous solution; and
(g) feeding the purified basic aqueous solution into at least one absorption column of step (a).

In a further aspect of the invention there is provided a system for performing a method according to the invention.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 shows an exemplary embodiment of a system of the invention.

FIG. 2 shows another exemplary embodiment of a system of the invention.

FIG. 3 shows the influence of the pH on the equilibrium concentrations of dissolved CO₂ products, e.g. CO₂, HCO₃⁻, CO₃⁻², and H₂CO₃. c_{T} is total concentration of all four forms of CO₂ [pCO₂=10^{-3.5} at (ambient concentration); pH adjusted with strong acid or strong base]—see W. Stumm and J. J. Morgan, ‘Aquatic Chemistry”, John Wiley and Sons, N.Y., p. 127, 1970).

### DETAILED DESCRIPTION OF EMBODIMENTS

In one aspect of the present invention there is provided a method of producing methane-enriched biogas (CH₄) from raw biogas, said method comprising the steps:
(a) introducing into at least one absorption column (i) raw biogas and (ii) a basic aqueous solution under conditions to permit solubilization of aqueous-soluble biogas components in the basic aqueous solution to obtain (i) methane-enriched biogas and (ii) at least one basic aqueous solution comprising aqueous-soluble biogas components;
(b) collecting the methane-enriched biogas;
(c) collecting the at least one basic aqueous solution comprising said aqueous-soluble biogas components;
(d) subjecting the at least one basic aqueous solution comprising said aqueous-soluble biogas components to a treatment for removal of said aqueous-soluble biogas components, to obtain a basic aqueous solution of step (a);
(e) feeding a first portion of the basic aqueous solution obtained in step (d) into at least one absorption column of step (a);
(f) subjecting a second portion of the basic aqueous solution obtained in step (d) to at least one biological purification process to obtain a purified basic aqueous solution; and
(g) feeding the purified basic aqueous solution into at least one absorption column of step(a).

The term “methane” and “methane-enriched biogas” as used herein interchangeably should be understood to encompass a gas substantially comprising CH₄. The term “substantially” as used herein is understood to encompass at least 88% methane.

Methane gas produced according to a method of the invention can be exploited for many uses including, but not limited to: generation of electricity by burning the methane gas as a fuel in a gas and steam turbine, fuel cells, internal combustion engines, steam boilers, injection into natural gas pipeline networks; domestic heating and cooking purposes for use with domestic appliances such as gas-powered ranges and/or ovens, gas-heated clothes dryers, heating/cooling conditioning devices, central heating, boilers, furnaces, and water heaters; fuel for vehicles and aircrafts (in the form of compressed or liquefied gas) which can be either dedicated natural gas vehicles running on natural gas only, or dual-fuel or bi-fuel vehicles which can also run on gasoline or diesel; potential rocket fuel; industrial chemical processes, such as for example in the chemical industry, where methane is the feedstock of choice for the production of hydrogen, methanol, acetic acid, acetic anhydride, acetylene and chloromethanes (such as chloromethane, dichloromethane, chloroform, and carbon tetrachloride); production of ammonia, for use in fertilizer production; and manufacture of fabrics, glass, steel, plastics, paint, and other products.

The term “raw biogas” as used herein should be understood to encompass landfill gas produced by the biological breakdown of any organic matter such as, but not limited to, manure or sewage sludge, food waste, municipal waste, and energy crops (such as maize silage made from field crops, oatlage for oats, haylage for alfalfa), in the absence of oxygen. Such decomposition is achieved by covering and compressing the waste mechanically by any mechanical method such as, but not limited to, by compressing with a weight deposited onto the waste, thereby preventing oxygen from accessing the waste and thereby promoting anaerobic microbes to thrive. Raw biogas composition varies depending upon its origin and may comprise organic and non-organic components. Typically, raw biogas comprises between about 50-75% CH₄, between about 25-50% CO₂, between about 0-10% N₂, between about 0-1% H₂, between about 0-3% H₂S, between about 0-0.3% CO, between about 0-500 ppm NH₃, and between about 0-2000 ppm Non-Methane Organic Compounds (NMOCs) such as, but not limited to, Ethane (C₂H₆), Ethyl Mercaptan (C₂H₆S), Propane (C₃H₈), Propene (Propylene) (C₃H₆), Butane (C₄H₁₀), 1-Butanol (C₄H₁₀O), and Ethylbenzene (C₈H₁₀), and between about 0-2% O₂. Additionally, raw biogas may also comprise siloxanes such as, but not limited to, Pentamethyldisiloxane (C₅H₁₆OSi₂), Hexamethyldisiloxane (C₆H₁₂OSi₂ HMDS), Octamethylcyclotetrasiloxane (C₈H₂₄O₄Si₄, D4), Hexamethylcyclotrisiloxane (C₁₂H₁₈O₃Si₃), Octamethylcyclotetrasiloxane (C₈H₂₄O₄Si₄), Decamethylcyclopentasiloxane (C₁₀H₃₀O₅Si₅), Dodecamethylcyclohexasiloxane (C₁₂H₃₆O₆Si₆), Hexamethyldisiloxane (C₆H₁₈Si₂O), Octamethyltrisiloxane (C₈H₂₄Si₃O₂), Decamethyltetrasiloxane (C₁₀H₃₀Si₄O₃), and Dodecamethylpentasiloxane (C₁₂H₃₆Si₅O₄). The raw biogas also comprises upto about 14% moisture.

In the method of the subject invention, raw biogas is continuously fed into at least one absorption column of step (a). The term “continuously” as used herein should be understood to encompass a constant feed of biogas into a system of the invention when operable.

The system of the invention is self-contained, i.e. the only component introduced into the system, when the system is operable, is raw biogas.

Part of the components of raw biogas such as, but not limited to, CO₂, H₂S, CO, NH₃, NMOCs, siloxanes and phosphates may be solubilized in a basic aqueous solution. Conditions which permit solubilization of such biogas components and the extent to which such components are being solubilized in a basic aqueous solution depend on the concentration of the components in raw biogas and on the pH of the basic aqueous solution. Solubilization of biogas components using a basic aqueous solution is also known as “scrubbing” or “stripping” of biogas. The solubilization process is a physical and chemical process. Typically, a biogas is pressurized and fed into a bottom of a column (at a pressure of for example 2 atm), i.e. an absorption column, into which a basic aqueous solution is fed to a top of said column (at a pressure higher than the pressure of the fed biogas) so that a solubilization process is operated counter-currently, wherein the partial pressure of a fed basic aqueous solution is lower than the partial pressure of a fed biogas. The difference in partial pressure enhances the absorbance of the solubilized gasses such as CO₂ and H₂S into a basic aqueous solution. The amount of gas dissolved in a basic aqueous solution, at a constant temperature, is directly proportional to the partial pressure of the gas in equilibrium with the aqueous basic solution.

Without being bound by theory, it is noted that once CO₂ and H₂S are solubilized in a basic aqueous solution, a chemical equilibrium is established according to the following reactions:

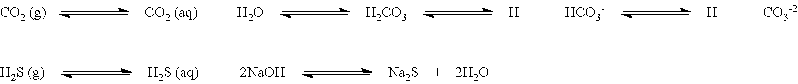

The concentration of the dissolved biogas components depends on the CO₂ and H₂S concentrations in the gas to be purified and on the pH of the basic aqueous solution.

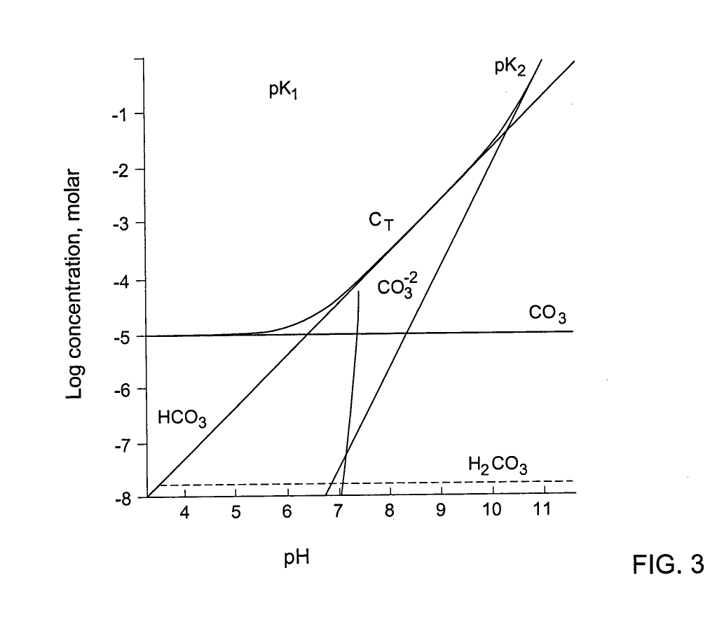

At high levels of pH, e.g. between about 8 to 11, the absorption of CO₂ is much higher than at lower pH levels as shown in FIG. 3. The total amount of CO₂ absorbed depends on the CO₂ content in the gas flow, the pH of the scrubbing liquid and the gas flow conducted through the scrubber.

The term “basic aqueous solution” refers to a solution which comprises at least one base, e.g. an electron pair donor molecule, such as, but not limited to, NaOH, KOH, Ca(OH)₂, Li(OH)₂, RbOH, Ba(OH)₂, CsOH, Sr(OH)₂, Mg(OH)₂ and/or any other bases know to a person skilled in the art or any mixtures thereof. Such bases, or mixtures thereof, when dissolved in water, give a solution with a pH higher than 7.0.

In one embodiment, said the at least one basic aqueous solution comprises NaOH and has a pH in the range of between about 6 to about 13. In a further embodiment, the pH of the at least one basic aqueous solution is between about 8 to about 11. In yet a further embodiment, the pH of the at least one basic aqueous solution is between about 6 to about 9.

It should be noted that the longer the residence time of biogas in a basic aqueous solution, the more efficient the solubilization of biogas components. Thus, increasing the number of absorption columns at step (a) and/or increasing the height of the at least one absorption column contributes to the level of the methane-enrichment of the biogas.

In one embodiment of the present invention, step (a) comprises at least two absorption columns. In one embodiment of the present invention, step (a) comprises two absorption columns. In another embodiment of the present invention, step (a) comprises three absorption columns. In yet another embodiment of the present invention, step (a) comprises four absorption columns. In yet another embodiment of the present invention, step (a) comprises five absorption columns. In yet another embodiment of the present invention, step (a) comprises six absorption columns and so forth.

In one embodiment of the invention, a basic aqueous solution is introduced into at least one absorption column. In another embodiment, a basic aqueous solution is introduced into two absorption columns. In another embodiment, a basic aqueous solution is introduced into three absorption columns and so forth.

In another embodiment, the purified basic aqueous solution of step (f) and methane-enriched biogas are fed into at least one absorption column in order to obtain further purified methane-enriched biogas and a further basic aqueous solution comprising aqueous-soluble biogas components. In a specific embodiment, said at least one absorption column is a last absorption column.

It should be understood that a “last absorption column” can be the last from any number of absorption columns, e.g. the last of two, the last of three, the last of four, the last of five, the last of six and so forth.

It is further understood, that the more absorption columns are used in a method of the invention, the more basic acqueous solutions will be generated in a method of the invention. In one embodiment of the invention, the basic aqueous solutions comprising aqueous-soluble biogas components obtained from the at least one absorption column (e.g. one, two, three and so forth absorption columns) are all combined prior to step (d).

Upon solubilization of raw biogas components in a basic aqueous solution, methane becomes an enriched component of the biogas, thereby obtaining “methane-enriched biogas”. Methane enriched biogas enriched according to a method of the invention comprises from about 94% to about 99% methane in said biogas. As noted herein, upon having at least two absorption columns in step (a), methane-enriched biogas becomes “further purified methane-enriched biogas”, wherein said methane is at levels of about 95% to 99%.

In a further embodiment of the present invention the height of said at least one absorption column is in the range of between about 3 to about 20 meters.

In a further embodiment of the present invention, all the basic aqueous solutions comprising aqueous-soluble biogas components are combined prior to step (d). It should be understood that the more absorption columns are used in a method of the invention, the more such basic aqueous solutions comprising aqueous-soluble biogas components will be combined prior to step (d). For example, if three absorption columns are used, than four basic aqueous solutions will be combined prior to step (d).

In one embodiment, a basic aqueous solution comprising aqueous-soluble biogas components obtained in step (a) is combined with a basic aqueous solution comprising aqueous-soluble biogas components obtained from any further absorption column from said at least one absorption column, prior to step (d).

In one embodiment of the invention, the treatment for removal of said aqueous-soluble biogas components in step (d) comprises at least one pressure release column, wherein the aqueous-soluble biogas components are gasified.

The term “pressure release column” as used herein is meant to encompass a column having a lower pressure, e.g. atmospheric pressure, as compared with a absorption column, whereby a pressure “swing” desorbs fully or partially the absorbed or solubilized biogas components thereby releasing for example gaseous CO₂ and H₂S from the column, which were absorbed in the basic aqueous solutions.

In yet a further embodiment, the gasified components are further subjected to at least one further absorption column comprising a non-organic absorption solution to obtain purified CO₂ and absorbed non-organic components. In one embodiment, said non-organic absorption solution comprises FeCl₂. FeCl₂ is capable of reacting with gaseous H₂S in a double replacement reaction as follows:

FeCl_{2 (aq)}+H₂S_{(g)}→FeS₍ₛ₎+2HCl_{(aq)}

Thus, H₂S released from a pressure release column is solubilized in the FeCl₂ solution, whereby the remaining gasified components comprise at least 95% of CO₂ collected at a top of an absorption column. In another embodiment, the remaining gasified components comprise at least 98% of CO₂ collected at a top of an absorption column.

After release of CO₂ and H₂S from at least one pressure release column, the resulting solution is a basic aqueous solution capable of being fed into the at least one absorption column. A first portion of a basic aqueous solution is fed into the at least one absorption column and a second portion of the basic aqueous solution is subjected to a biological purification process to obtain a purified basic aqueous solution. The volume ratio between first and second portion of said basic aqueous solution may be between about 1:1 in one embodiment to about 20:1 in a different embodiment, or any other ratio there in between.

In one embodiment, said biological process comprises subjecting the second portion of said basic aqueous solution (obtained in step (d)) to at least one type of microorganism capable of biologically decomposing organic and non-organic biogas components in the presence of air, to obtain a purified basic aqueous solution and decomposed organic and non-organic components.

The types of microorganisms capable of aerobically decomposing organic and non-organic biogas components as used in a method of the invention may be selected from the following none-limiting list: eucaryotes (such as protista), multi cellular eukaryotes (such as algae, fungi, protozoa, plants including seed plans, ferns and mosses), eubacteria, sulfur-oxidizing bacteria (such as anoxygenic photosynthetic purple and green sulfur bacteria), colorless sulfur bacteria (e.g. archaebacteria), and so forth.

It should be noted that the decomposed organic and none-organic components of biogas resulting from the aerobic biological treatment in step (f) are environmentally none-harmful and may be descanted cheaply and safely using e.g. a waste-water treatment process and may e.g. be disposed at landfills and used as compost.

In yet another embodiment, the method of the invention further comprises introducing said purified basic aqueous solution with air into at least one pressure release column to obtain a further purified basic aqueous solution.

In this further pressure release column, traces of aqueous CO₂ are removed by pressurizing the purified basic aqueous solution after biological treatment and spraying it against air stream. The difference in pressure releases the solubilized CO₂ from the purified basic aqueous solution thereby obtaining said further purified basic aqueous solution.

In one embodiment of the present invention, said purified basic aqueous solution has a pH range between about 8.5 to about 13. In another embodiment, said purified basic aqueous solution has a pH range between about 8.5 to about 11. In yet another embodiment, said purified basic aqueous solution has a pH range between about 10 to about 13. In yet a further embodiment of the present invention, said purified basic aqueous solution has a pH range between about 11 to about 12. In yet a further embodiment of the present invention, said purified basic aqueous solution has a pH range between about 12 to about 13.

In one embodiment, the pH of the at least one basic aqueous solution is lower than the pH of the purified basic aqueous solution.

In another aspect of the invention, there is provided a system for performing a method according to the invention.

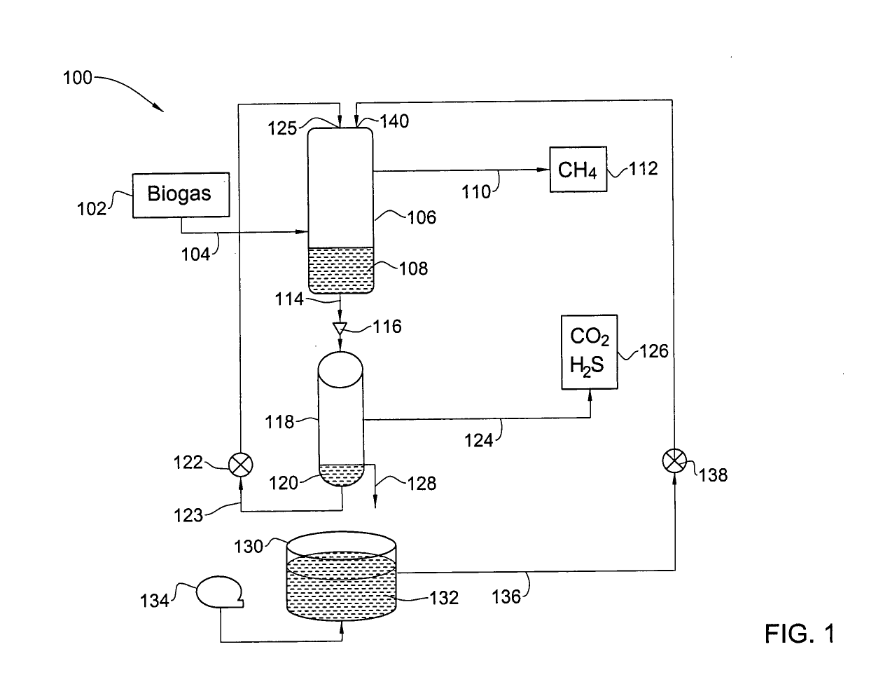

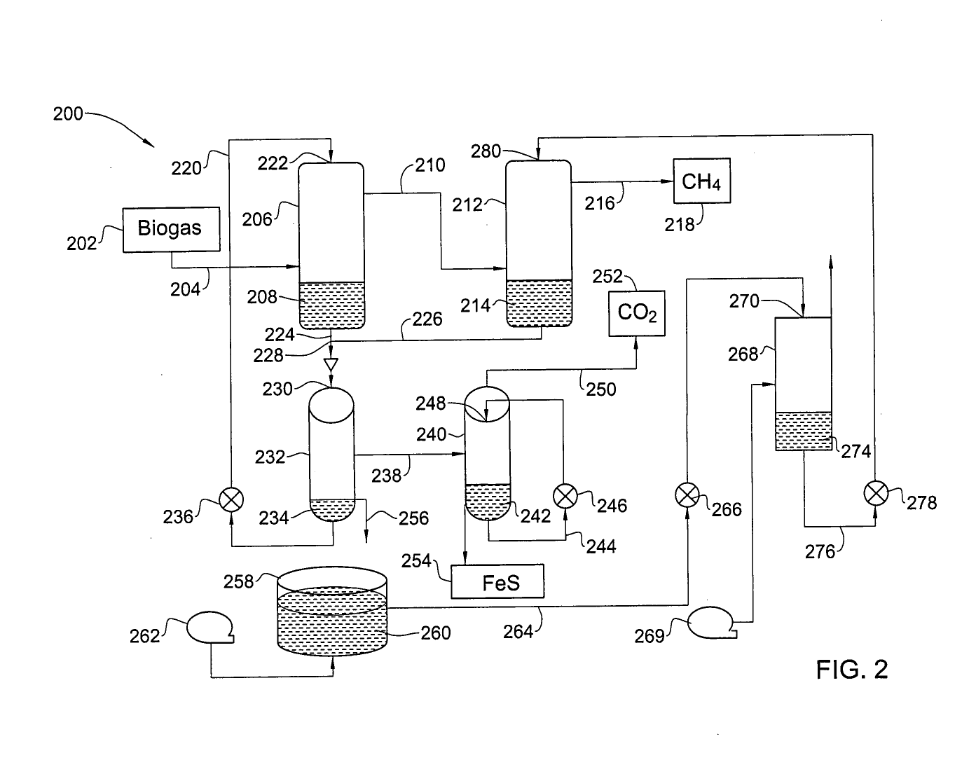

The invention is further described by reference to FIGS. 1 and 2, which are not in any way intended to limit the scope of the inventions as claimed.

Reference is made to FIG. 1, showing a schematic depiction of a system in accordance with an embodiment of the invention. The system generally designated 100 includes a container comprising raw biogas 102 which is delivered via a pipeline 104 to a bottom part of an absorption column 106 comprising a basic aqueous solution 108 at its lower part in order to prevent gas leakage at the bottom of the column. A pipe 110 delivers an enriched methane gas to a collecting vessel 112.

The excess basic aqueous solution formed at the bottom of absorption column 106 is delivered via pipe 114 through at least one jet aperture 116 to a top part of pressure release column 118 which is under atmospheric pressure and capable of gasifying aqueous CO₂ and H₂S from the basic aqueous solution delivered via pipe 114. A first portion of basic aqueous solution 120 at a bottom part of pressure release column 118 is fed into absorption column 106 using a pump 122. The first portion of aqueous solution 120 is fed through pipe 123 into absorption column 106, through at least one jet aperture 125 in order to achieve pressure difference between the basic aqueous solution and the biogas entering the column and in order to obtain maximal surface area exposure of the biogas and the basic aqueous solution.

The gas comprising CO₂ and H₂S released from pressure release column 118, is fed through a pipe 124 to a collecting container 126.

A second portion of basic aqueous solution 120 at the bottom part of pressure release column 118 is fed trough pipe 128 to a container 130 comprising at least one type of microorganism 132 capable of aerobically decomposing organic and non-organic components comprised in said second portion of basic aqueous solution. Air is fed into container 130 via a blower 134. Purified basic aqueous solution is fed through pipe 136 via pump 138 to a top part of absorption column 106 through at least one jet aperture 140.

Reference is now made to FIG. 2, showing a schematic depiction of a system in accordance with an embodiment of the invention. The system generally designated 200 includes a container comprising raw biogas 202 which is delivered via a pipeline 204 to a bottom part of a first absorption column 206 comprising a basic aqueous solution 208 at its lower part in order to prevent gas leakage at the bottom of the column. The system further comprises a pipe 210 delivering methane enriched biogas from a top part of absorption column 206 to a second absorption column 212 comprising basic aqueous solution 214 in order to prevent gas leakage at the bottom of the column. A pipe 216 delivers the further enriched methane biogas to a collecting vessel 218.

To a top of absorption column 206 a basic aqueous solution is delivered through a pipe 220. The solution is transferred into absorption column 206 through at least one jet aperture 222 in order to achieve pressure difference between the basic aqueous solution and the biogas entering the column and in order to obtain maximal surface area exposure of the biogas and the basic aqueous solution. The excess basic aqueous solution formed at the bottom of absorption column 206 and the excess basic aqueous solution formed at the bottom of absorption column 212 are delivered via pipes 224 and 226. Both solutions are combined at 228 and delivered through at least one jet aperture 230 to a top part of pressure release column 232 which is under atmospheric pressure and capable of gasifying aqueous CO₂ and H₂S from the combined basic aqueous solutions delivered via pipes 224 and 226. A first portion of aqueous solution 234 at a bottom part of pressure release column 232 is fed into absorption column 206 using a pump 236.

The released gas comprising CO₂ and H₂S is fed through a pipe 238 to a bottom part of absorption column 240. Absorption column 240 comprises absorption solution 242 comprising FeCl₂ at the bottom part of the column (below gas pipe 238 entry). The absorption solution 242 is fed through a pipe 244 using a pump 246 to a top part of absorption column 240, wherein it is jet sprayed through at least one jet aperture 248 in order to facilitate the absorption of H₂S. The produced salt is collected at the bottom of the column to a collecting container 254. The remaining gas comprising mainly CO₂ is delivered through pipe 250 to a collecting vessel 252.

A second portion of aqueous solution 234 at the bottom part of pressure release column 232 is fed trough pipe 256 to a container 258 comprising at least one type of microorganism 260 capable of aerobically decomposing organic and non-organic components comprised in said second portion of basic aqueous solution. Air is fed into container 258 via a blower 262. Purified basic aqueous solution is fed through pipe 264 via pump 266 to a pressure release column 268 for the release of trace of CO₂ in purified basic aqueous solution. The solution is fed through at least one jet aperture 270 at a top part of release column 268. Additionally, air via a blower 269 is fed into a bottom part of release column 268. The resulting gas comprising CO₂ and air is released through exhaust 272. The resulting further purified basic aqueous solution 274 at the bottom part of the column is fed through pipe 276 via pump 278 to a top part of second absorption column 212, where it is fed through at least one jet aperture 280.

1. A method of producing methane-enriched biogas from raw biogas, said method comprising the steps:
(a) introducing into at least one absorption column (i) raw biogas and (ii) a basic aqueous solution under conditions to permit solubilization of aqueous-soluble biogas components in the basic aqueous solution to obtain (i) methane-enriched biogas and (ii) at least one basic aqueous solution comprising aqueous-soluble biogas components;
(b) collecting the methane-enriched biogas;
(c) collecting the at least one basic aqueous solution comprising said aqueous-soluble biogas components;
(d) subjecting the at least one basic aqueous solution comprising said aqueous-soluble biogas components to a treatment for removal of said aqueous-soluble biogas components, to obtain a basic aqueous solution of step (a);
(e) feeding a first portion of the basic aqueous solution obtained in step (d) into at least one absorption column of step (a);
(f) subjecting a second portion of the basic aqueous solution obtained in step (d) to at least one biological purification process to obtain a purified basic aqueous solution; and
(g) feeding the purified basic aqueous solution into at least one absorption column of step (a).

2. The method according to claim 1, wherein the at least one basic aqueous solution comprises NaOH and has a pH in the range of between about 6 to about 13.

3. The method according to claim 2, wherein the pH of the at least one basic aqueous solution is between about 8 to about 11.

4. The method according to claim 1, wherein step (a) comprises at least two absorption columns.

5. The method according to claim 4, wherein the purified basic aqueous solution of step (f) and methane-enriched biogas are fed into a last absorption column, in order to obtain further purified methane-enriched biogas and a further basic aqueous solution comprising aqueous-soluble biogas components.

6. The method according to claim 5, wherein the purified basic aqueous solution has a pH range between about 8.5 to about 13.

7. The method according to claim 5, wherein the basic aqueous solutions comprising aqueous-soluble biogas components are combined prior to step (d).

8. The method according to claim 1, wherein the treatment of step (d) comprises at least one pressure release column, wherein the aqueous-soluble biogas components are gasified.

9. The method according to claim 8, wherein the gasified components are subjected to at least one absorption column comprising a non-organic absorption solution to obtain purified CO₂ and absorbed non-organic components.

10. The method according to claim 9, wherein said the non-organic components comprise H₂S.

11. The method according to claim 9, wherein said the non-organic absorption solution comprises FeCl₂.

12. The method according to claim 1, wherein the biological purification process comprises reacting the second portion of the basic aqueous solution obtained in step (d) with at least one type of microorganism capable of biologically decomposing organic and non-organic biogas components in the presence of air, to obtain the purified basic aqueous solution and decomposed organic and non-organic components.

13. The method according to claim 12, further comprising introducing the purified basic aqueous solution with air to at least one pressure release column to obtain a further purified basic aqueous solution.

14. The method according to claim 13, wherein the further purified basic aqueous solution is fed into at least one absorption column.

15. A system for performing a method according to claim 1.
